(19) United States
(12) Patent Application Publication
(10) Pub. No.: US 2025/0128276 A1
(43) Pub. Date: Apr. 24, 2025

(54) ELECTROSTATIC COATING MACHINE

(71) Applicant: Carlisle Fluid Technologies, LLC, Scottsdale, AZ (US)

(72) Inventors: Tatsuya Nakaishi, Yokohama (JP); Daisuke Ota, Yokohama (JP)

(21) Appl. No.: 18/691,531

(22) PCT Filed: Dec. 22, 2022
(86) PCT No.: PCT/US2022/053813

§ 371 Date: Mar. 13, 2024

Related U.S. Application Data
(60) Provisional application No. 63/292,712, filed on Dec. 22, 2021.

(51) Int. Cl. B05B 5/04

(52) U.S. Cl. CPC B05B 5/0407; B05B 5/0415

(57) ABSTRACT

An electrostatic coating machine can include an applicator rotatably attached to a distal end of a turbine and shaft, wherein the applicator is a bell cup comprising a resin material, wherein the bell cup comprises an outer peripheral edge and a bell cup exposed surface, wherein the outer peripheral edge comprises a conductive or semi-conductive coating material, and a plurality of semi-conductive members extending through the resin material in electrical communication with a high voltage path and the outer peripheral edge.

### CROSS-REFERENCE TO RELATED APPLICATIONS

This application is a national stage application under 35 USC. § 371 of international application PCT/US2022/053813, titled “ELECTROSTATIC COATING MACHINE,” filed 22 Dec. 2022, which claims priority to and the benefit of U.S. Provisional Application for Patent 63/292,712, filed 22 Dec. 2021, titled “ELECTROSTATIC COATING MACHINE.” Priority to and the benefit of both of these applications is claimed in the present application, and both are incorporated as if fully rewritten herein.

### BACKGROUND

Disclosed is an electrostatic coating machine, and specifically, an electrostatic coating machine comprising an applicator rotatably attached to a distal end of a turbine and shaft, wherein the applicator is a bell cup comprising a resin material, wherein the bell cup comprises an outer peripheral edge and a bell cup exposed surface, wherein the outer peripheral edge comprises a conductive or semi-conductive coating material, the improvement comprising a plurality of semi-conductive members extending through the resin material in electrical communication with a high voltage path and the outer peripheral edge.

### SUMMARY

An electrostatic coating machine can include an applicator rotatably attached to a distal end of a turbine and shaft, wherein the applicator is a bell cup comprising a resin material, wherein the bell cup comprises an outer peripheral edge and a bell cup exposed surface, wherein the outer peripheral edge comprises a conductive or semi-conductive coating material, and a plurality of semi-conductive members extending through the resin material in electrical communication with a high voltage path and the outer peripheral edge.

### BRIEF DESCRIPTION OF THE FIGURES

FIG. 1 is a cutaway view of an example, non-limiting electrostatic coating machine of the embodiments herein.

FIG. 2 is a view of an example, non-limiting bell cup of the embodiments herein

FIG. 3 is a cutaway view of an example, non-limiting bell cup of the embodiments herein.

### DETAILED DESCRIPTION

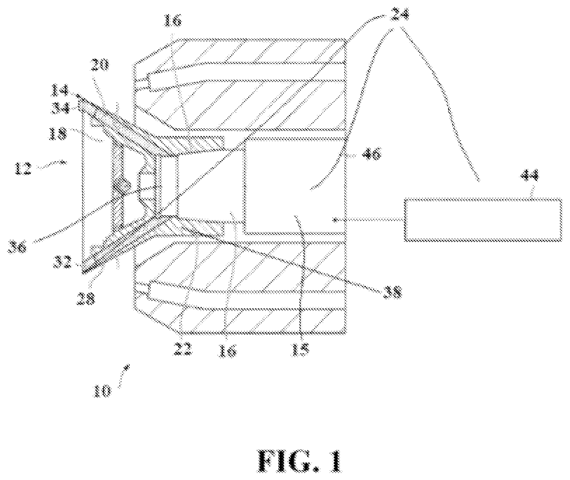

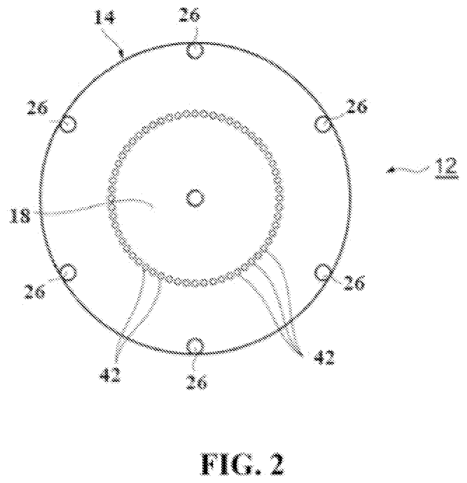

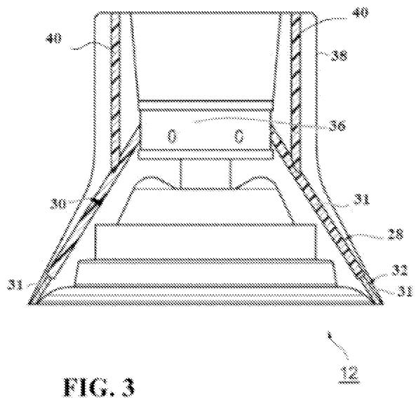

Embodiments of the present invention will be described in detail below with reference to the drawings. Note that the present invention is not limited to the following description. It will be readily appreciated by those skilled in the art that modes and details of the present invention can be modified in various ways without departing from the spirit and scope of the present invention. The present invention therefore should not be construed as being limited to the following description of the embodiments. Note that in structures described below, the same portions or portions having similar functions are denoted by the same reference numerals in different drawings, and the description thereof is omitted. As shown in FIGS. 1-3, an electrostatic coating machine 10 can include an applicator 12 rotatably attached to a distal end of a turbine 15 and shaft 16, wherein the applicator 12 is a bell cup 12 comprising a resin material 22, wherein the bell cup 12 comprises an outer peripheral edge 14 and a bell cup 12 exposed surface 18, wherein the outer peripheral edge 14 comprises a conductive or semi-conductive coating material, and a plurality of semi-conductive members 20 extending through the resin material 22 in electrical communication with a high voltage path 24 and the outer peripheral edge 14. The high voltage path 24 can include a cascade 44, air motor 46, and the outer peripheral edge 14, and all electrical connections therebetween, which can include a bell cup connector 36 and the semi-conductive member 20. The resin material 22 can be, for example polyetheretherketone resin, polycarbonate resin, polypropylene resin, epoxy resin and the like The semi-conductive member 20 can comprise, consist of, or consist essentially of a semi-conductive material 31 in which a carbon-based or metal conductive powder can be kneaded into an epoxy-based resin, a phenol-based resin, ceramics, or the like. This material can be cured by heat treatment to become a semi-conductive member 20. The turbine 15 can be an air motor 46.

In some embodiments, a conductive sealing member 26 electrically connects each semi-conductive member 20 to the outer peripheral edge 14, wherein the conductive sealing member 26 forms a portion of a bell cup 12 exposed surface 18. The sealing member can comprise, consist of, or consist essentially of aluminum or another conductive metal. According to certain embodiments, the plurality of semi-conductive members 20 includes at least four semi-conductive members 20. In some embodiments, the plurality of semi-conductive members 20 includes at least six semi-conductive members 20, and wherein the plurality of semi-conductive members 20 are evenly radially spaced. In some embodiments, each of the semi-conductive members 20 comprises a large diameter cylindrical portion 28 comprising a first diameter 30. According to certain embodiments, each of the semi-conductive members 20 comprises a small diameter cylindrical portion 32, wherein the small diameter cylindrical portion 32 comprises a second diameter 34, wherein the second diameter 34 is smaller than the first diameter 30, and wherein small diameter cylindrical portion 32 extends from direct adjacent contact with the large diameter cylindrical portion 28 to the bell cup 12 exposed surface 18. According to certain embodiments, a rear portion 38 of the bell cup 12 is in mechanical communication with the distal end of the shaft 16 through a semi-conductive bell cup connector 36 at a rear portion 38 of the bell cup 12. In some embodiments, the bell cup 12 comprises filling cylinders 40 that extend through the bell cup 12 rear portion 38 to the semi-conductive members 20. In some embodiments, the semi-conductive bell cup connector 36 has a resistance value of at least 90 ohms and less than 120 ohms. In certain embodiments, the semi-conductive bell cup connector 36 has a resistance value of at least 100 ohms and less than 115 ohms. In certain embodiments, the semi-conductive bell cup connector 36 has a resistance value of at least 104 ohms and less than 110 ohms. According to certain embodiments, the bell cup 12 comprises a plurality of paint holes 42 configured to deliver paint to the bell cup 12 exposed surface 18. While the above describes certain embodiments of the invention, it should be understood that the embodiments are exemplary. References in the specification to a given embodiment indicate that the embodiment described may include a particular feature, structure, or characteristic, but every embodiment may not necessarily include the particular feature, structure, or characteristic. Finally, while given components have been described separately, one of ordinary skill will appreciate that some of the components can be combined or shared in other combinations.

We claim:

1. In an electrostatic coating machine comprising an applicator rotatably attached to a distal end of a turbine and shaft, wherein the applicator is a bell cup comprising a resin material, wherein the bell cup comprises an outer peripheral edge and a bell cup exposed surface, wherein the outer peripheral edge comprises a conductive or semi-conductive coating material, the improvement comprising: a plurality of semi-conductive members extending through the resin material in electrical communication with a high voltage path and the outer peripheral edge.

2. The improvement of claim 1, wherein a conductive sealing member electrically connects each semi-conductive member to the outer peripheral edge, wherein the conductive sealing member forms a portion of a bell cup exposed surface.

3. The improvement of claim 2, wherein the plurality of semi-conductive members includes at least four semi-conductive members.

4. The improvement of claim 3, wherein the plurality of semi-conductive members includes at least six semi-conductive members, and wherein the plurality of semi-conductive members are evenly radially spaced.

5. The improvement of claim 3, wherein each of the semi-conductive members comprises a large diameter cylindrical portion comprising a first diameter.

6. The improvement of claim 5, wherein each of the semi-conductive members comprises a small diameter cylindrical portion, wherein the small diameter cylindrical portion comprises a second diameter, wherein the second diameter is smaller than the first diameter, and wherein small diameter cylindrical portion extends from direct adjacent contact with the large diameter cylindrical portion to the bell cup exposed surface.

7. The improvement of claim 1, wherein a rear portion of the bell cup is in mechanical communication with the distal end of the shaft through a semi-conductive bell cup connector at a rear portion of the bell cup.

8. The improvement of claim 7, wherein the bell cup comprises filling cylinders that extend through the bell cup rear portion to the semi-conductive members.

9. The improvement of claim 8, wherein the semi-conductive bell cup connector has a resistance value of at least 90 ohms and less than 120 ohms.

10. The improvement of claim 9, wherein the semi-conductive bell cup connector has a resistance value of at least 100 ohms and less than 115 ohms.

11. The improvement of claim 10, wherein the semi-conductive bell cup connector has a resistance value of at least 104 ohms and less than 110 ohms.

12. The improvement of claim 1, wherein the bell cup comprises a plurality of paint holes configured to deliver paint to the bell cup exposed surface.
